(19) United States
(12) Patent Application Publication
(10) Pub. No.: US 2013/0009395 A1
(43) Pub. Date: Jan. 10, 2013

(54) SANITARY CLAMP WITH RADIAL SEAL

(75) Inventors: Jeromy D. Horning, Albertville, MN (US); Steve J. Wrobel, Rogers, MN (US); James M. Dalton, Elk River, MN (US); Christopher A. Lins, Crystal, MN (US); Craig T. Kurvers, Sartell, MN (US)

(73) Assignee: Graco Minnesota Inc., Minneapolis, MN (US)

(21) Appl. No.: 13/635,515

(22) PCT Filed: Mar. 16, 2011
(86) PCT No.: PCT/US11/28647

§ 371 Date: Sep. 17, 2012

Related U.S. Application Data
(60) Provisional application No. 61/315,288, filed on Mar. 18, 2010.

(51) Int. Cl. F16L 21/02

(52) U.S. Cl. 285/337

(57) ABSTRACT

A coupler utilizes a conventional sanitary clamp member 12 having a handle 14 releasably clamping first and second halves 16 and 18 together. The inner surface of halves 16 and 18 is provided with a groove 20 having angled sides 20a and 20b which serve to axially press together male 22 and female 28 members together as handle 14 is tightened. Male member 22 has a generally cylindrical plug 24 with end 30 which extends into socket 28b of female member 28. An O-ring 26 is located on the circumference of plug 24 and seals against the inner cylindrical surface of socket 28b.

### TECHNICAL FIELD

This application claims the benefit of U.S. application Ser. No. 61/315,288, filed Mar. 18, 2010, the contents of which are hereby incorporated by reference.

### BACKGROUND ART

Industry standard clamps that lock two halves of a piping system together are well known. Such clamps have a threaded fitting that can tighten the two halves that are hinged.

### DISCLOSURE OF THE INVENTION

It is an object of this invention to provide a quick disconnect that uses an industry standard sanitary clamp, retains a gasket seal, allows the operator to easily align the parts, and can be used for high pressure applications.

The system uses an industry standard clamp that locks two halves of a piping system together. The clamp has a threaded fitting that can tighten the two halves that are hinged. The system tightens on two angles on the clamp and flanges so the fit is tight with hand torque. The seal is designed using an o-ring that compresses radially verses a seal that is compressed axially.

The sanitary clamp member is traditionally used for ½″ or ¾″ tube connections where the seal is a face seal design which seals between the two flat faces of the pieces being clamped. This design does not capture the seal so it can be dropped and lost. The seal is compressed axially and not radially. The design was meant for drop in replacement of components in a piping system. The instant invention has adopted the clamp member to be used for a quick disconnect that captures the seal and aligns the two halves before the clamp is applied for easy of assembly. The seal diameter is also smaller so it will generate lower forces due to pressure so the overall pressure rating can be higher.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows a cross-section of the quick disconnect of the instant invention.

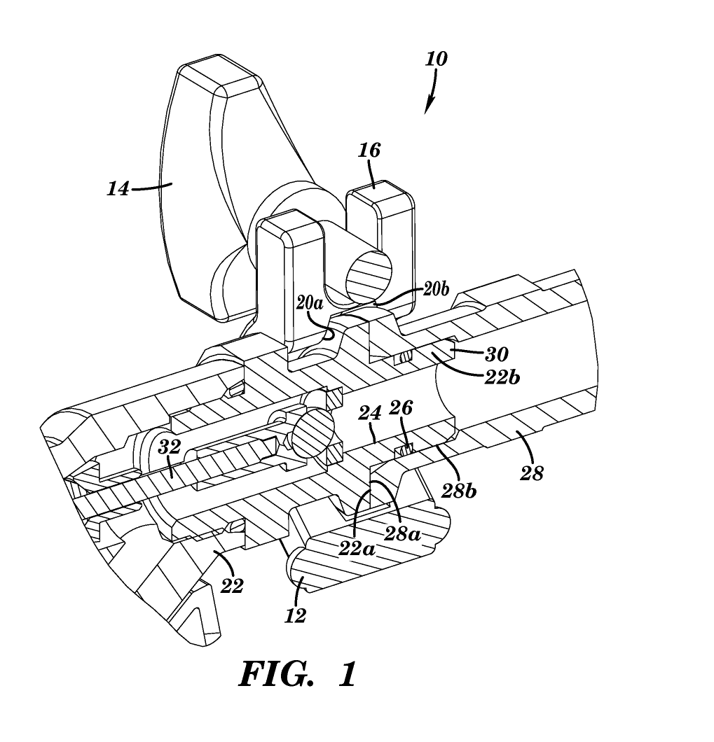

FIG. 2 shows a view of a standard sanitary clamp member used with the instant invention.

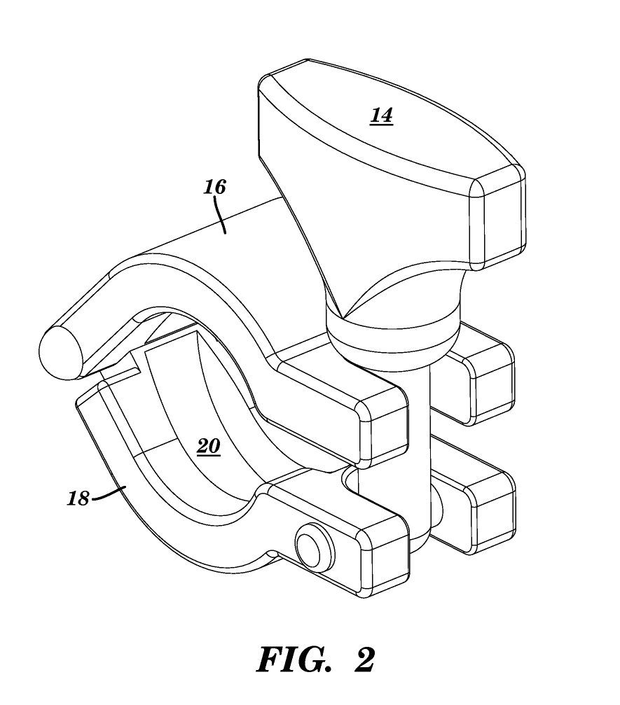

FIG. 3 shows the uncoupled quick disconnect.

FIG. 4 shows the coupled quick disconnect.

### BEST MODE FOR CARRYING OUT THE INVENTION

The coupler, generally designated 10, of the instant invention is comprised of a conventional sanitary clamp member 12 having a handle 14 of releasably clamping first and second halves 16 and 18 together. The inner surface of halves 16 and 18 is provided with a groove 20 having angled sides 20a and 20b which serve to axially press together male 22 and female 28 members together as handle 14 is tightened.

Male member 22 has a generally cylindrical plug 24 with end 30 which extends into socket 28b of female member 28. An O-ring 26 is located on the circumference of plug 24 and seals against the inner cylindrical surface of socket 28b. Face 22a of male member 22 and face 28a of female member 28 are pressed against one another to both seal and hold both members in rigid axial alignment with one another.

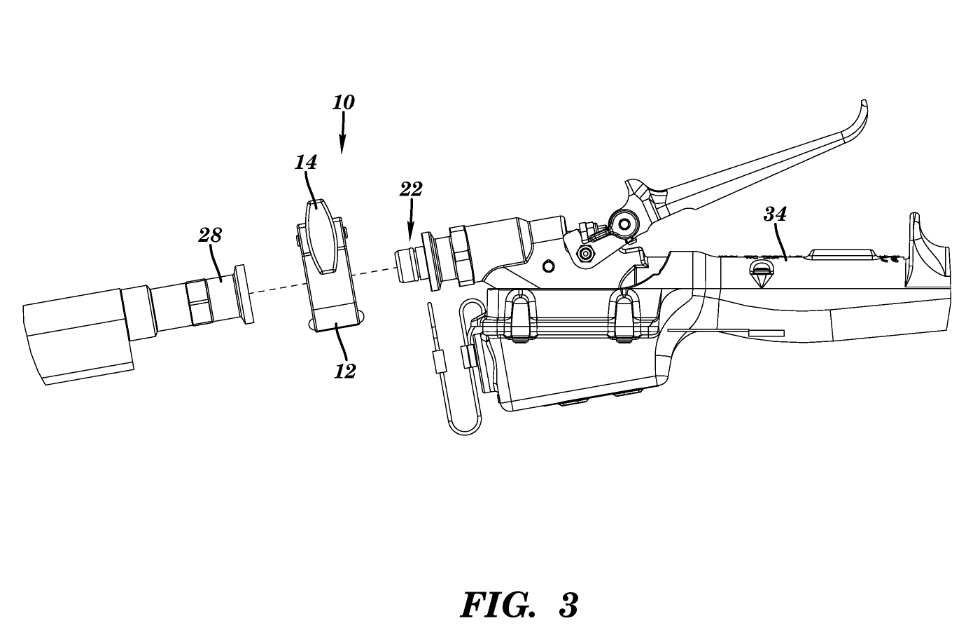

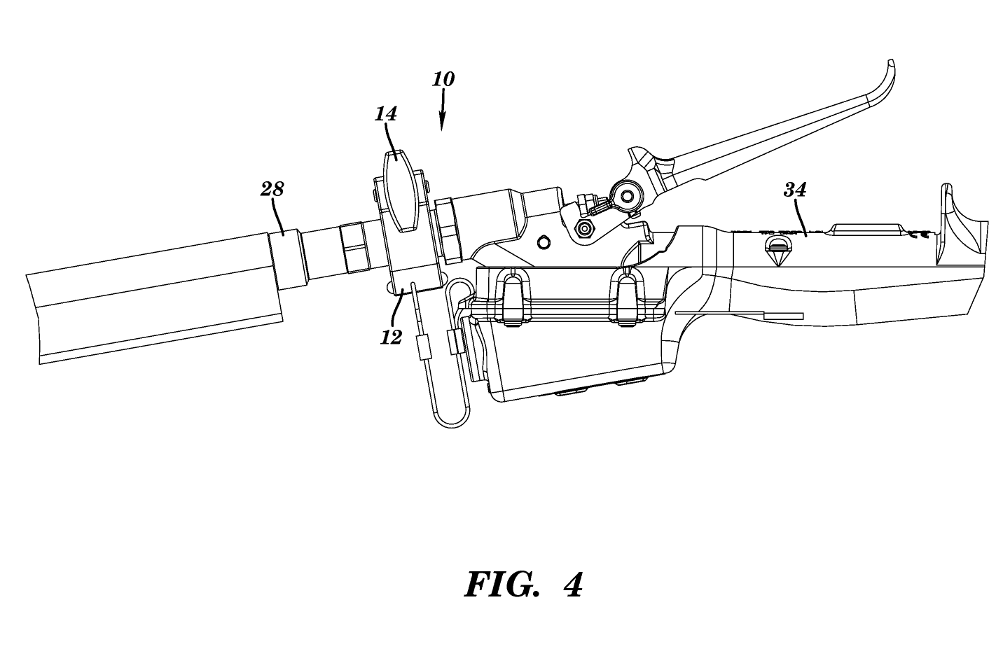

As shown in FIGS. 3 and 4, male member 22 is located on the control valve 34 (having valve element 32) and female member 28 is located on application device 36. Of course, the location of the two members may be reversed as desired.

It is contemplated that various changes and modifications may be made to the coupler without departing from the spirit and scope of the invention as defined by the following claims.

1. A fluid coupler comprising:
a sanitary clamp member comprising:
first and second halves;
a handle for releasably clamping said halves together, the inner surface of said halves being provided with a groove having angled sides;
a male member having a face and a generally cylindrical plug having a circumference;
a female member having a face and a socket having an inner cylindrical surface, said male member being removably extendable into said socket;
an O-ring located on the circumference of said plug and sealing against said inner cylindrical surface of said socket, whereby said male member face and said female member face are pressed against one another to both seal and hold both members in rigid axial alignment with one another when said handle is tightened.
